(19) United States
(12) Patent Application Publication
(10) Pub. No.: US 2026/0057728 A1
(43) Pub. Date: Feb. 26, 2026

(54) BEVERAGE SALES SYSTEM

(71) Applicant: Lebledor F&B Co., Ltd., New Taipei City (TW)

(72) Inventor: Kuan Ting YEH, New Taipei City (TW)

(73) Assignee: Lebledor F&B Co., Ltd., New Taipei City (TW)

(21) Appl. No.: 19/301,369

(22) Filed: Aug. 15, 2025

(30) Foreign Application Priority Data
Aug. 26, 2024 (TW) 113132054

(51) Int. Cl. G07F 13/00; G06Q 30/0283

(52) U.S. Cl. CPC G07F 13/00; G06Q 30/0283

(57) ABSTRACT

A beverage sales system including a display wall plate, a plurality of beverage dispensing devices, a plurality of billing devices, a display interface, and a control device is disclosed. The plurality of beverage dispensing devices are configured to provide beverages differing in flavors or brands. Each billing device is adapted to calculate the monetary amount corresponding to the quantity of beverage dispensed by the associated beverage dispensing device per dispensing operation, and to record the amount on a storage medium. The control device is operatively connected to the display interface and includes a pricing mechanism, whereby the selling price of the beverage dispensed from each beverage dispensing device can fluctuate dynamically through the pricing mechanism and can be reflected and displayed in real time on the display interface.

### FIELD OF THE INVENTION

The present invention relates to a beverage sales system, specifically relates to a beverage sales system with a simple structure that is entertaining and easy to operate.

### BACKGROUND OF THE INVENTION

In recent years, sports bars and sports-themed restaurants have emerged as popular new destinations for many individuals. These venues offer a space where patrons need not compete with family members for the television, allowing them to enjoy live broadcasts of sporting events with friends and fellow fans, cheering for their favorite teams or athletes. Additionally, these establishments provide a relaxed atmosphere for enjoying drinks and gourmet food. This trendy setting integrates elements of sports, fashion, and contemporary culture, continuously broadcasting various sporting events and the latest trends, creating an immersive viewing experience akin to being at the live event.

Among the best-selling items in sports bars or sports restaurants are alcoholic beverages. In addition to offering seasonal or promotional drinks during specific events to attract customers, some operators have introduced self-service beverage bars. These allow consumers to serve themselves—dispensing as much as they wish based on personal preference—and to customize their drinks accordingly. Payment may be made via an electronic card systems, with consumption recorded through contactless payments, for example, at a rate of approximately New Taiwan dollar (NT$) 0.5 to 1 per milliliter.

Although existing self-service beverage dispensing systems offer consumers a novel experience distinct from traditional models, today’s consumers continuously seek new experiences and innovations in consumption. Therefore, how to enhance the consumer experience or atmosphere in current sports bars or sports restaurants, thereby maximizing benefits for both consumers and operators, has been the central focus of the present inventor’s research.

### SUMMARY OF THE INVENTION

The primary objective of the present invention is to provide a beverage sales system with a simplified structure, ease of operation, and enhanced user engagement through interactive and entertaining features.

In order to achieve the above and other objectives, the present invention provides a beverage sales system that includes a display wall plate, a plurality of beverage dispensing devices, a plurality of billing devices, a display interface and a control device. The plurality of beverage dispensing devices are disposed at intervals on the display wall plate, and each beverage dispensing device is individually connected to a beverage supply device, and the beverage supply devices contain beverages differing in flavors or brands. Each of the billing devices is positioned at one side of each of the beverage dispensing devices and is operatively connected to the respective beverage dispensing device for calculating a monetary amount of the volume of the beverage dispensed each time by the respective beverage dispensing device, and records it on a storage medium.The display interface is disposed on the display wall plate. The control device is operatively connected to the display interface, and the control device includes a pricing mechanism for dynamically changing the selling price of the beverage dispensed from each beverage dispensing device and generating price fluctuations through the pricing mechanism, and the changes is reflected and displayed in real time on the display interface.

In an implementation, the control device is operatively connected to each of the billing devices for recording the sales figures of beverages dispensed from each beverage dispensing device, and the pricing mechanism is adapted to dynamically recalculate and adjust the selling prices of the dispensed beverages based on the recorded sales figures of the beverages dispensed from each beverage dispensing device, so as to generate price fluctuations and display them in real time on the display interface.

In an implementation, the control device further includes a manual pricing mechanism configured to allow on-site staff to manually adjust the price of each beverage dispensed by the beverage dispensing devices, so as to generate price fluctuations and display them on the display interface.

In an implementation, an information display screen is arranged at one side of each of the beverage dispensing devices for providing information corresponding to the beverage dispensed by the beverage dispensing device.

In an implementation, the information display screen includes at least the name, the selling price, ingredients and an introduction of an origin of the beverage.

In an implementation, the storage medium is a contactless card, and the contactless card is electronically sensed by the billing device before the beverage dispensing device is activated to dispense a beverage and the corresponding price calculated.

The foregoing features and advantages of the present invention will become more apparent from the following detailed description taken in conjunction with the accompanying drawings.

### BRIEF DESCRIPTION OF THE DRAWINGS

FIG. 1 is an external schematic view of a beverage sales system in accordance with an embodiment of the present invention.

FIG. 2 is a block diagram of the beverage sales system in accordance with an embodiment of the present invention.

FIG. 3 is a schematic view showing a usage state of the beverage sales system in accordance with an embodiment of the present invention.

FIG. 4 is another schematic view showing another usage state of the beverage sales system in accordance with an embodiment of the present invention.

### DETAILED DESCRIPTION OF THE EMBODIMENTS

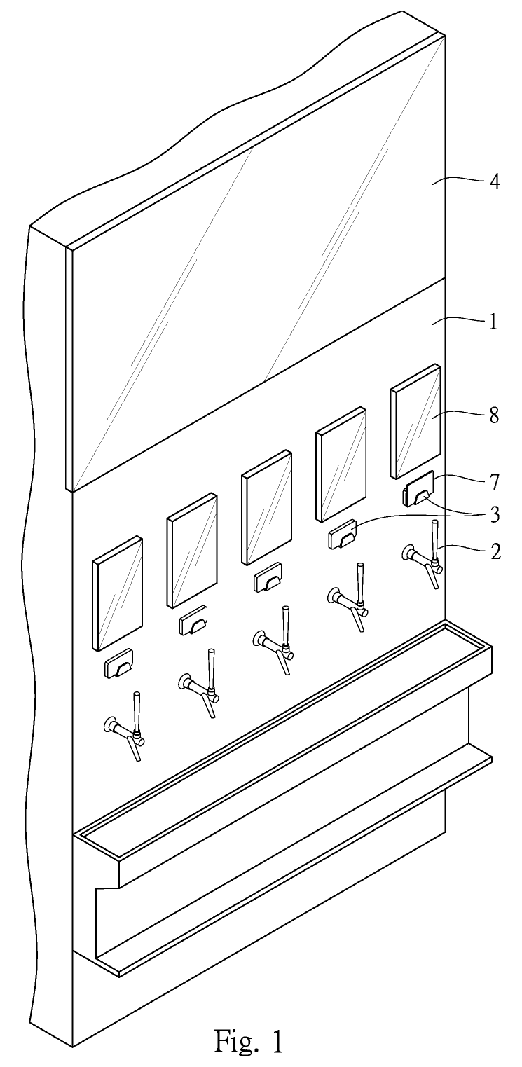

Please refer to FIGS. 1 to 4, which illustrate an embodiment of the beverage sales system in accordance with the present invention.

The beverage sales system disclosed herein primarily comprises a display wall plate 1, a plurality of beverage dispensing devices 2, a plurality of billing devices 3, a display interface 4, and a control device 5.

The display interface 4 is mounted on the display wall plate 1, and the beverage dispensing devices 2 are arranged at intervals on the display wall plate 1. Each beverage dispensing device 2 is individually connected to a beverage supply device 6, and each beverage supply device 6 contains a beverage differing in flavor or brand. For example, one beverage dispensing device may be connected to a beverage supply device containing cola, another to one containing whiskey, and yet another to one containing wheat beer, etc.

Each billing device 3 is disposed on one side of a corresponding beverage dispensing device 2 (FIG. 1 illustrates an embodiment where the billing devices are installed above the dispensing devices), and is operatively connected to the corresponding beverage dispensing device 2. The billing device 3 calculates the cost of the beverage volume dispensed each time from the corresponding beverage dispensing device 2 and records it onto a storage medium 7. The storage medium 7 may be a contactless card, which is electronically sensed by the billing device 3 before the beverage dispensing device 2 is activated to dispense beverage and the corresponding price is calculated. The sensing method may be contact or contactless. The contactless card can be a debit card, credit card, stored-value card, or other payment instruments. As shown in FIG. 1 (contact-based sensing), in one implementation, the beverage (cola) dispensing device 2 may be charging New Taiwan Dollar (NT$) 0.3 per milliliter (ml), and when the consumer taps the storage medium 7 ( a contactless card) on the billing device 3, the beverage dispensing device 2 is activated to pour the beverage into the consumer’s cup. The billing device 3 then calculates the volume being dispensed in ml and stores the monetary amount in the storage medium 7 (the contactless card). The consumer may later settle the payment using the storage medium 7 (the contactless card).

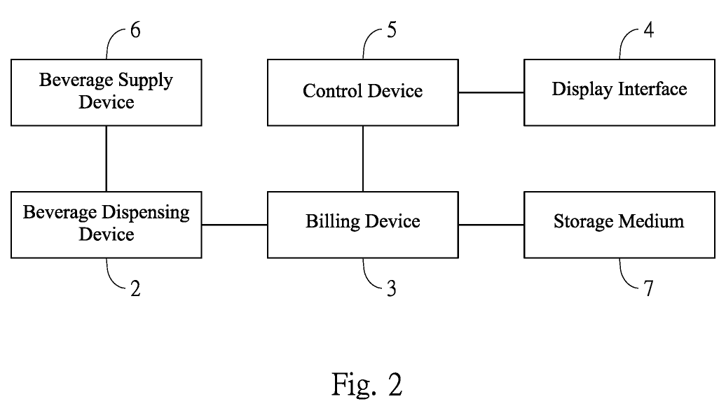

As shown in FIGS. 2 to 4, the control device 5 is operatively connected to the display interface 4 and includes a pricing mechanism. This mechanism allows the price of each beverage dispensed from the beverage dispensing devices 2 to dynamically fluctuate based on various parameters. These price changes are reflected and displayed in real time on the display interface 4.

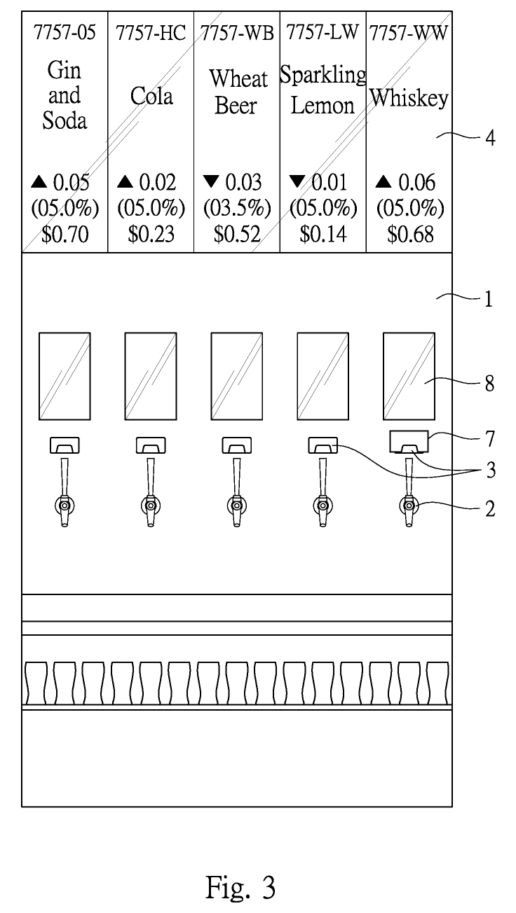

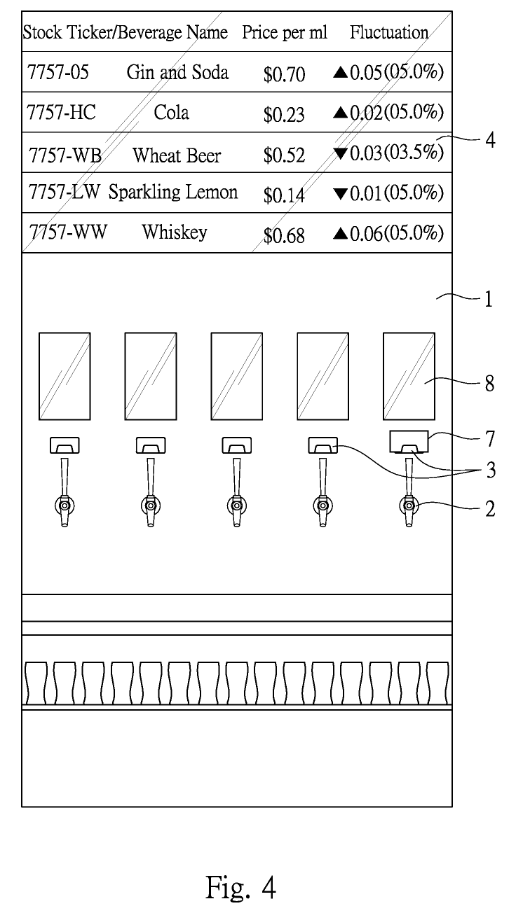

In one implementation, the control device 5 is connected to each of the billing devices 3 to record the sales figures of the beverage dispensed from each beverage dispensing device 2. The pricing mechanism can recalculate and adjust the selling prices of the beverages based on the sales figures of each of the beverage dispensing devices 2, so as to generate price fluctuations and display them in real time on the display interface 4. For instance, when sales of whiskey exceed a preset threshold defined in the pricing mechanism, the pricing mechanism then raises the price of the whiskey through a pricing formula, and the new price is displayed as text or a symbol (e.g., a price up symbol used in the stock market) on the display interface 4. Similarly, as an example, when sales of wheat beer meets a determination criterion in the pricing mechanism (the determination criterion may include sales being below a preset threshold), the pricing mechanism then reduces the price using the pricing formula, and the reduced price is also displayed using text or a symbol (e.g., a price drop symbol used in the stock market) on the display interface 4, as illustrated in FIGS. 3 and 4.

Moreover, in actual implementation, the control device 5 may further include a manual pricing mechanism that allows on-site staff to manually adjust the price of the beverage dispensed by each of the beverage dispensing devices 2. These price fluctuations are reflected in real time on the display interface 4. For example, during a live sports broadcast, staff may adjust the prices of the beverages dispensed by the beverage dispensing devices 2 via the control device 5 to support a particular team—for instance, offering a 50% discount on all drinks for 10 minutes or launching a limited-time promotion on a specific beverage—thus enhancing the celebratory atmosphere for fans supporting their favorite teams.

Additionally, next to each beverage dispensing device 2 on the display wall plate 1, an information display screen 8 corresponding to the beverage dispensed by the associated device 2 is provided. The information display screen 8 displays at least information such as the name, the selling price, the ingredients, and the introduction to the origin of the particular beverage.

Accordingly, the present invention provides the following advantages:

1. The design of the present invention allows consumers to independently choose and sample any of the beverages provided. After tasting a small amount, they may refill their cup with the preferred drink or mix their own custom blend. Pricing is based on volume, avoiding the issue of ordering a full cup of a beverage they may not enjoy.

2. The design in accordance with the present invention breaks away from the traditional full-cup sales model. Consumers can dispense the desired amount and are charged accordingly, minimizing waste and reducing unnecessary spending.

3. The pricing mechanism of the control device in accordance with the present invention allows drink prices to be adjusted dynamically based on the sales figures. High-demand drinks increase in price, while low-demand drinks decrease in price. This incentivizes consumers to try lesser-sold drinks and helps balance inventory of the beverages, reducing issues related to slow turnover or product expiration.

4. The pricing mechanism in accordance with the present invention can also be tied to real-time factors such as the atmosphere of the venue, stock market trends, sports match results, or in-house promotional games, enabling dynamic promotions that stimulate purchasing behavior and energize the environment, thereby attracting consumers and increasing the likelihood of future visits.

5. The display interface in accordance with the present invention, modeled after stock market displays, clearly presents the current price and fluctuations of each beverage, delivering a unique and engaging consumer experience.

The above descriptions provide embodiments of the present invention and the technical means employed. Various changes and modifications can be derived in light of the disclosure or teachings of the present application, and are therefore deemed as equivalents to the concepts of the present invention. The effects resulted from such changes and modifications should be construed as within the technical scope of the present invention to the extent that they do not exceed the substantive spirit covered by the present application and the drawings.

In summary, based on the above descriptions, the present invention provides a beverage sales system with practicality and industrial value, and a patent application is hereby filed in accordance with the law.

What is claimed is:

1. A beverage sales system comprising:
a display wall plate,
a plurality of beverage dispensing devices disposed at intervals on the display wall plate, each beverage dispensing device being individually connected to a beverage supply device, and the beverage supply devices containing beverages differing in flavors or brands;
a plurality of billing devices, each of the billing devices being positioned at one side of each of the beverage dispensing devices and operatively connected to the respective beverage dispensing device for calculating a monetary amount of the volume of the beverage dispensed each time by the respective beverage dispensing device, and recording it on a storage medium;
a display interface disposed on the display wall plate; and
a control device operatively connected to the display interface including a pricing mechanism for dynamically changing a selling price of the beverage dispensed from each beverage dispensing device and generating price fluctuations through the pricing mechanism, the changes being reflected and displayed in real time on the display interface, wherein the control device is operatively connected to each of the billing devices for recording the sales figures of beverages dispensed from each beverage dispensing device, and the pricing mechanism is adapted to dynamically recalculate and adjust the selling prices of the dispensed beverages based on the recorded sales figures of the beverages dispensed from each beverage dispensing device, so as to generate price fluctuations and display them on the display interface.

2. The beverage sales system of claim 1, wherein the control device further comprises a manual pricing mechanism configured to allow on-site staff to manually adjust the selling price of the beverage dispensed by each of the beverage dispensing devices,so as to generate price fluctuations and displaythem on the display interface.

3. The beverage sales system of claim 1, wherein an information display screen is arranged at one side of each of the beverage dispensing devices for providing information corresponding to the beverage dispensed by the beverage dispensing device.

4. The beverage sales system of claim 3, wherein the information display screen includes at least the name, the selling price, ingredients and an origin of the beverage.

5. The beverage sales system of claim 1, wherein the storage medium is a contactless card, and the contactless card is electronically sensed by the billing device before the beverage dispensing device is activated to dispense the beverage and the corresponding price is calculated.
